(19) United States
(12) Patent Application Publication
(10) Pub. No.: US 2024/0353294 A1
(43) Pub. Date: Oct. 24, 2024

(54) WATER-SOLUBLE TACKINESS COMPOSITION

(71) Applicant: COMMISSARIAT A L'ENERGIE ATOMIQUE ET AUX ENERGIES ALTERNATIVES, Paris (FR)

(72) Inventor: Frédéric REVOL-CAVALIER, Grenoble cedex 09 (FR)

(73) Assignee: COMMISSARIAT A L'ENERGIE ATOMIQUE ET AUX ENERGIES ALTERNATIVES, Paris (FR)

(21) Appl. No.: 18/637,912

(22) Filed: Apr. 17, 2024

(30) Foreign Application Priority Data
Apr. 21, 2023 (FR) 23 04041

(51) Int. Cl. G01N 1/02

(52) U.S. Cl. CPC G01N 1/02; G01N 2001/028

(57) ABSTRACT

A water-soluble composition may include: a solution of polyvinyl alcohol (PVA) or of polyvinylpyrrolidone (PVP); CaCl₂ and/or MgCl₂ in a range of from 10 to 50 wt. %. The composition may include: polyvinyl alcohol or polyvinylpyrrolidone in a range of from 10 to 20 wt. % in an aqueous solution; glycerol in a range of from 20 to 40 wt. %; and CaCl₂ and/or MgCl₂ in a range of from 10 to 30 wt. %.

### TECHNICAL FIELD OF THE INVENTION

The present invention relates to a water-soluble composition, which can be used notably for the collecting of particles.

### PRIOR ART

The collecting of particles present on a surface is of use for various applications, notably:
checking the effectiveness of a decontamination after pollution,
carrying out analyses on the particles collected,
checking the contamination of containers and worktops employed in the food-processing industry, and the like.

In all these applications, it is of use to have available a device which makes it possible to carry out a simple and rapid sampling of particles. The term “particles” is understood to mean all types of biological compounds, such as bacteria, DNA molecules, spores, viruses, or any other type of particles, such as beads, dust, biofilm or pollen.

Devices for the collecting of particles are already known in the state of the art. The commonest solutions use “cotton swabs” or brushes which are applied to the surface in order to sample the particles present. The collected particles are subsequently detached from the sampling tool by immersion in a specific buffer solution. Detection kits, generally strips, are subsequently used to determine the nature of the contamination. These solutions are effective provided that there is significant contamination (stain, suspicious powder, and the like). On the other hand, when the contamination is slight, it is necessary to carry out collecting of greater scale in order to increase the number of particles collected.

For the collecting of particles over a large surface area, there exist items of equipment in the form of a suction device or collector. This type of equipment comprises a compressor which sends sterile water under pressure into a spray head which detaches contaminating materials from the treated surface (fabric, fibrous surface, and the like). A second zone of the spray head also makes it possible to recover, by suction, the water laden with particles. The water and the particles sucked up are recovered in a tank and will be subsequently analysed in a laboratory. This device is focused on DNA recovery but might also be used for other contaminating materials (particles, bacteria, spores, and the like). However, this solution proves to be particularly cumbersome.

Another technique used in the food industry to ascertain that a part of a manufacturing line is contaminated by bacteria consists in using sterile sponges to collect bacteria after having moistened the collecting zone with a buffer solution. The sponge will collect the deposited liquid with the bacteria, then the liquid will be recovered and cultured for a few hours or days to check for the presence of bacteria. However, in this solution, bacteria can get stuck to the surface of the material constituting the sponge (polyurethane, polypropylene, and the like) and consequently not be present in the recovered liquid. Furthermore, these sponges are not suitable for collecting particles over a large surface area and can even spread the contamination from a soiled place A to an unsoiled place B. Finally, the sponge often needs to be moistened prior to the collecting.

The patent application referenced FR 2 366 554 A1 (corresponding to U.S. Pat. No. 4,144,760) describes a sampling device using a water-soluble plastic which, after moistening, becomes sticky and makes possible the capture of biological particles on a surface by affixing. Once the capture is complete, the plastic film is partially or completely dissolved in order to collect the captured elements. This technique requires prior moistening of the plastic film in order to partially dissolve it and to make it sticky. This stage is very problematic because, if the moistening is insufficient, the material is not sticky enough and, if it is too great, the material dissolves and no longer performs its function of collecting.

The documents WO2017/209628A1, US2011/256531A1 and U.S. Pat. No. 4,144,760 A1 also describe sampling devices.

Patent Application EP 3 591 372 A1 describes a device for sampling particles present on a surface. The device is provided in the form of a foam roller impregnated with a water-soluble material, this material making it possible to collect the particles and to easily redissolve them. The water-soluble material is provided in the form of a gel or film deposited on the surface of the roller. By way of example, the gel is a composition which comprises polyvinyl alcohol (PVA), water and glycerol.

After a certain storage period, this type of gel tends to lose its tackiness, which renders the device inoperative. The addition of an alcohol (such as glycerol) makes it possible to delay the drying of the film but does not make it possible to preserve the sticky characteristics of the film.

Patent Applications US2009/196849A1 and CN116345C both describe water-soluble compositions used in various fields.

The aim of the invention is to provide a water-soluble composition capable of retaining its tackiness over time, thus making it possible for a particle-collecting device using this composition to be able to be used at all times, even after long-term storage.

### STATEMENT OF THE INVENTION

This aim is achieved by the use of a water-soluble composition for the collecting of particles on a surface, said composition comprising:
a solution of polyvinyl alcohol (PVA) or of polyvinylpyrrolidone (PVP);
from 10% to 50% by weight of a compound chosen from:
   a salt chosen from CaCl₂ and MgCl₂.

According to a particular implementation, the composition also comprises up to 50% by weight of glycerol.

Advantageously, the composition comprises: from 10% to 20% of polyvinyl alcohol (PVA) or of polyvinylpyrrolidone (PVP) in an aqueous solution, to which from 20% to 40% by weight of glycerol and from 10% to 30% by weight of salt chosen from CaCl₂ and MgCl₂ are added.

Preferably, the composition comprises:
10% of polyvinyl alcohol (PVA) or of polyvinylpyrrolidone (PVP) in water, then
30% by weight of glycerol, and
20% by weight of a CaCl₂ salt.

The invention also relates to a particle-collecting device, comprising a support exhibiting a collecting surface and a material of water-soluble type deposited on its collecting surface, the water-soluble material using a water-soluble composition as defined above.

### BRIEF DESCRIPTION OF THE FIGURES

Other characteristics and advantages will become apparent in the detailed description which follows, made with regard to the appended drawings, in which:

FIGS. 1A and 1B represent an implementational example of a particle-collecting device, for example produced in the form of a roller;

FIG. 2 shows the different stages which are employed for a collecting of particles using the particle-collecting device represented in FIG. 1A;

FIG. 3 shows a diagram showing the collecting efficiency as a function of the storage period of a collecting device.

### DETAILED DESCRIPTION OF AT LEAST ONE EMBODIMENT

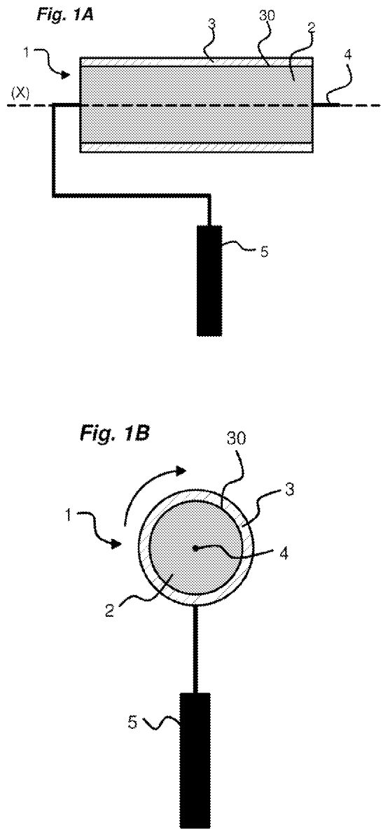

A particle-collecting device 1 as represented in FIGS. 1A and 1n FIG. 1B comprises, for example, a support 2 provided with a collecting surface 30. In this implementation, the support 2 can be formed by a roller in the form of a cylinder of revolution exhibiting a lateral surface forming said collecting surface 30. The roller can be fitted rotating about a rod 4 forming an axis of rotation (X). The rod 4 can be connected to a gripping handle 5 of the device.

The device comprises a water-soluble material, at least partially covering its collecting surface 30, advantageously covering the entire collecting surface 30 of the support.

The water-soluble material is provided in the form of a gel 3 or of a film. The term “gel” is understood to mean a material which comprises a sufficient viscosity, notably of between 500 MPa·s and 50 000 MPa·s.

The gel 3 is deposited on the collecting surface 200 of the support 2. In the case of a support in the form of a roller, it is thus deposited on the lateral surface of the roller.

The support 2 can be made entirely of a non-deformable material, for example a hard plastic, or of an elastically deformable material, such as a deformable foam, such as, for example, a polymer foam, for example of polyurethane (PU), polyvinyl chloride (PVC), polyethylene (PE) or silicone type.

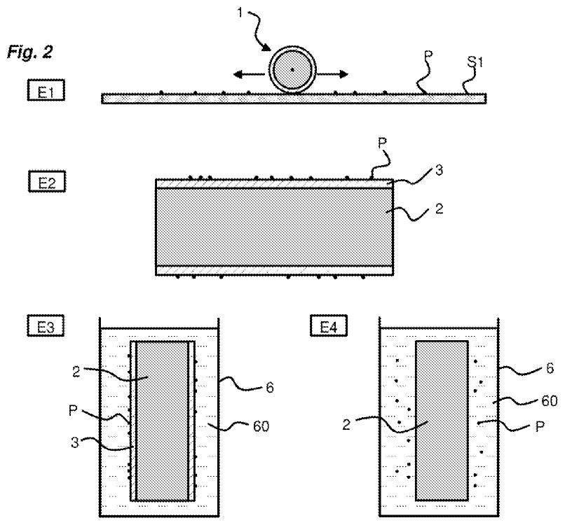

The principle of a collecting of particles is illustrated by FIG. 2.

With reference to FIG. 2, the various stages of the collecting method carried out using a collecting device 1 as described above are as follows:
E1: The device 1 is ready for use and does not require any preparation. This is because the gel 3 is already present on the collecting surface 30 of the roller and the device is always ready for use.
E2: the roller is affixed to the surface S1 to be sampled (flat surface here in this example) so as to bring the gel 3 present on the roller into contact with the surface S1 to be sampled. The passage of the roller over the surface S1 to be sampled makes it possible to drive the roller in rotation about its axis (X). During the application of the roller, the particles P present on the surface S1 to be sampled are detached from the surface to be sampled and will stick to the gel 3. Several passes may be necessary.
E3: The particles P are collected on the collecting surface 30 of the device. In order to be recovered, the collecting surface is immersed, at least partially or even entirely, in an aqueous solution 60, for example an aqueous buffer (for example, phosphate-buffered saline-PBS), present in a collecting tank 6. To facilitate the immersion, the support 2 in its entirety can be separated from the remainder of the device.
E4: During the immersion of the collecting surface, the gel 3 dissolves in the aqueous solution 60, thus releasing the collected particles P into the solution. An analysis of the aqueous solution 60 will subsequently make it possible to identify the particles P which have been collected.

According to the invention, the gel is composed of:
a solution of polyvinyl alcohol (PVA) or of polyvinylpyrrolidone (PVP) present in a proportion of between 5% and 30% in an aqueous solution,
from 10% to 50% by weight of a compound chosen from:
   a salt, such as CaCl₂ or MgCl₂,
from 0% to 50% by weight of glycerol.

It should be noted that the presence of glycerol is optional.

The PVP solution is obtained, for example, by dissolving 13 g of polyvinylpyrrolidone in 150 ml of distilled water. After complete dissolution, 30% by weight of glycerol and then 20% by weight of CaCl₂ are added, for example.

Advantageously, a composition according to the invention is as follows:
from 10% to 20% of PVA or PVP in water, then
from 20% to 40% of glycerol, and
from 10% to 30% by weight of MgCl₂ or CaCl₂ in the solution.

A preferential composition is, for example, as follows:
10% of PVP or PVA in water, then
30% of glycerol, and
20% by weight of CaCl₂ in the solution.

According to a particular aspect of the invention, by adding a salt, such as CaCl₂ or MgCl₂, the drying of the gel is delayed and the sticky characteristics of the material are preserved over time.

The salt chosen is advantageously that composed of CaCl₂.

According to a distinguishing feature, the gel can thus be deposited on the collecting surface of the roller in order to obtain complete covering of its surface.

The surface of the roller, thus covered, is subsequently heated for a further length of time in an oven in order to dry the gel on the surface of the roller. The roller is then ready for use. On leaving the oven, the roller is surrounded by a non-stick film in order to protect the sticky gel.

The roller can be stored at atmospheric pressure or deposited in a bag and placed under vacuum.

Of course, the gel might be deposited on the collecting surface of a collecting device having another architecture (cotton swab, brush, sponge, sphere, beads, and the like).

It should be noted that the composition described above might be employed for applications other than the collecting of particles, such as, for example, as hydrogel in ECG or EEG measurements, or as adhesive which does not dry or dries very slowly.

The tackiness of the composition was tested during two tests.

It was first tested for the collecting of polystyrene beads of 5 μm to 10 μm in diameter, distributed over a surface area of 1 m².

For the polystyrene beads, the protocol was as follows:
Stage No. 1: Deposition of the beads contained in an aqueous solution on the surface to be treated.

Deposition is carried out by dispensing drops of liquid on the surface or using a spray which dispenses drops containing the beads on the surface.
Stage No. 2: Waiting for the complete drying of the drops containing the beads on the surface-4 h at ambient temperature.
Stage No. 3: Passing the roller over the surface.
Stage No. 4: Introducing the roller into a tank containing 10 ml of aqueous solution.
Stage No. 5: Stirring (30 seconds) the tank in order for the water contained in the tank to be in contact with the surface of the roller and to dissolve the sticky film.
Stage No. 6: Recovering a calibrated volume of solution (20 μl) and depositing on a counting slide.
Stage No. 7: Counting the number of beads recovered in the 20 μl sample and comparing with the amount of beads initially deposited on the surface.

The collecting principle is also validated with regard to Bacillus thuringiensis spores.

Protocol used for Bacillus thuringiensis spores
Stage No. 1: Preparation of the spore solution with counting of the spores in the initial solution.
Stage No. 2: Deposition is carried out by dispensing, on the surface, a defined volume (1 ml) of the liquid drops or using a spray which dispenses drops containing the spores on the surface.
Stage No. 2: Waiting for the complete drying of the drops containing the spores on the surface-4 h at ambient temperature.
Stage No. 3: Passing the roller over the surface.
Stage No. 4: Introducing the roller into a tank containing 10 ml of aqueous solution.
Stage No. 5: Stirring (30 seconds) the tank in order for the water contained in the tank to be in contact with the surface of the roller and to dissolve the sticky film.
Stage No. 6: Depositing 100 μl of solution on a suitable culture dish.
Stage No. 7: Placing in an incubator at 36° C. overnight.

Counting the number of colonies on the culture dishes and comparing with the number of spores deposited on the surface.

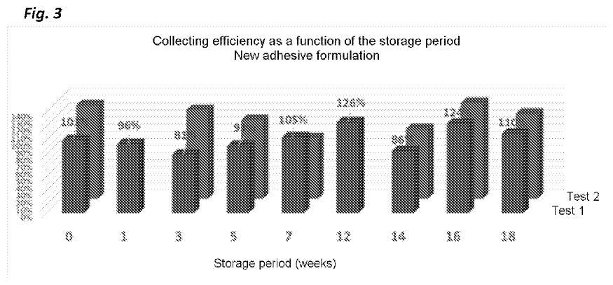

In both cases, in connection with FIG. 3, no loss in collecting efficiency was observed, regardless of the storage period of the roller. This means that the roller, impregnated with the composition of the invention, has retained its tackiness over time. With regard to the spores, the roller has, for example, made it possible to collect 90% of the spores dispensed on a surface area of 2 m², even after a storage period of 9 weeks.

The invention exhibits numerous advantages, among which are:
the guarantee of preservation of the tackiness of the composition over time, even after a long storage period;
ease of manufacture of the composition;
5-ease of use of the composition;
obtaining a ready-to-use tool;
the possibility of recovering all of the particles collected by the roller in the solution for dissolution of the gel.

1. A method of collecting particles on a surface, the method comprising:
contacting a particle with a water-soluble composition,
wherein the water-soluble composition comprises:
a solution comprising polyvinyl alcohol or polyvinylpyrrolidone; and
CaCl2 and/or MgCl2 in a range of—from 10 to 50 wt. %.

2. The method of claim 1, wherein the composition further comprises glycerol in up to 50 wt. %.

3. The method of claim 1, wherein the composition comprises:
the polyvinyl alcohol or the polyvinylpyrrolidone in a range of from 10 to 20 wt. % in an aqueous solution;
glycerol in a range of from 20 to 40 wt. %; and
the CaCl2 and/or the MeCl2 in a range of from 10 to 30 wt. %.

4. The method of claim 1, wherein the composition comprises:
the polyvinyl alcohol or the polyvinylpyrrolidone in 10 wt. % in water;
glycerol in 30 wt. %; and
the CaCl2 in 20 wt. %.

5. A particle-collecting device, comprising:
a support comprising a collecting surface; and
the water-soluble material of claim 1, deposited on the collecting surface.

6. A mixture, comprising:
particles on a surface; and
an aqueous solution comprising (i) polyvinyl alcohol or polyvinylpyrrolidone and (ii) CaCl₂ and/or MgCl₂ in a range of from 10 to 50 wt. %,
wherein the solution contacts at least one particle.

7. The mixture of claim 6, wherein the composition further comprises glycerol in up to 50 wt. %.

8. The mixture of claim 6, wherein the solution comprises:
water;
the polyvinyl alcohol or the polyvinylpyrrolidone in a range of from 10 to 20 wt. % in;
glycerol in a range of from 20 to 40 wt. %; and
the CaCl₂ and/or the MgCl₂ in a range of from 10 to 30 wt. %.

9. The mixture of claim 6, wherein the composition comprises:
the polyvinyl alcohol or the polyvinylpyrrolidone in 10 wt. % in water;
glycerol in 30 wt. %; and
the CaCl₂ in 20 wt. %.

10. The method of 1, wherein the solution comprises the polyvinylpyrrolidone.

11. The method of 1, wherein the solution comprises the polyvinylpyrrolidone.

12. The method of 1, wherein the composition comprises the CaCl₂.

13. The method of 1, wherein the composition comprises the MgCl₂.
